(19) United States
(12) Patent Application Publication
(10) Pub. No.: US 2011/0149282 A1
(43) Pub. Date: Jun. 23, 2011

(54) Polarimeter and Polarimetry Method

(75) Inventor: Jeff Wagner, Long Valley, NJ (US)

(73) Assignee: Rudolph Research Analytical, Hackettstown, NJ (US)

(21) Appl. No.: 12/641,459

(22) Filed: Dec. 18, 2009

(51) Int. Cl. G01J 4/00

(52) U.S. Cl. 356/364

(57) ABSTRACT

A polarimeter and polarimetry method are disclosed of the type in which light polarization rotating properties of a sample are measured by interposing the sample in the path of a light beam having base plane polarization in a plane of known orientation; along the beam path, compensating or nulling the rotation introduced by the sample, and determining the optical rotational properties of the sample based on the amount of compensation introduced to the light beam. In accordance with one aspect of the present invention, the light beam is subjected to plural compensations along its path the compensations being of at least two different types. Preferably, one of the types of compensation is mechanical, introduced through a device in which polarization rotation is adjusted mechanically, and the second type of compensation is provided through a device in which polarization rotation is controlled electrically. In accordance with another aspect of the invention, a first polarization rotation compensation is performed with the sample in the beam path, the sample is removed, and compensation is restored by performing a second polarization rotation compensation, the second compensation being used to determine the polarization rotation introduced by the sample.

### BACKGROUND OF THE INVENTION

The present invention relates generally to polarimetry and, more particularly, concerns a multiple wavelength polarimetry method and apparatus which achieve high resolution measurement, while avoiding errors due to stray magnetic fields or stray reflections

Polarimetry is the measurement and interpretation of the polarization of transverse waves, such as radio or light waves. Typically polarimetry is done on electromagnetic waves that have traveled through or have been reflected, refracted, or diffracted by some material in order to characterize that material. Polarimetry can be used to measure various optical properties of a material, including linear birefringence, circular birefringence (also known as optical rotation or optical rotary dispersion), linear dichroism, circular dichroism and scattering.

A polarimeter is the basic scientific instrument used to make these measurements. To measure these various properties, there have been many designs of polarimeters. Typical polarimeters are based on arrangements of polarizing filters, wave plates or other devices.

FIG. 1 is a schematic block diagram of a first type of prior art polarimeter. Light source 1 projects a beam of substantially parallel light through a fixed polarizer 2, which causes the light beam to be polarized in a single, predetermined plane (hereafter referred to as the “base” plane). The polarized light beam is then introduced to a Faraday cell 3 under control of a signal generator 7. It is a property of the Faraday cell that it will modify the plane of polarization of the light beam in relationship with a signal provided by the signal generator 7. In this case, signal generator 7 produces an oscillating signal, so the light signal emanating from Faraday cell 3 exhibits a plane of orientation which oscillates about the base plane beam produced by polarizer 2. The light beam with oscillating polarization is then passed through a sample cell 4 which contains a substance being tested. The substance in sample cell 4 has an optically active constituent which introduces an additional amount of rotation of the plane of polarization to a light beam passing through it.

The light beam emanating from sample cell 4 then passes through an analyzer 5, which has a rotatable polarizer 5a driven by a motor 8 under control of a controller 9. The output of analyzer 5 is provided to a phase sensitive detector 6, which also receives a signal from generator 7, and it is therefore responsive to the received beam to produce a signal representing the difference in beam polarization direction between light emanating from analyzer 5 and light emanating from sample cell 4. Phase sensitive detector 6 produces a signal representing the rotation difference which is provided to controller 9.

More specifically, the intensity of the beam arriving at detector 6 is proportional to the cosine squared of the angle between the polarization directions of the beam exiting from cell 4 and the beam emanating from analyzer 5. An analysis of this intensity variation with time determines the direction of the minimum angle separating the analyzer polarization direction and the sample cell polarization direction. By design, that angle is maintained sufficiently small relative to the amplitude of the oscillating polarization produced by the Faraday cell 3 to permit determination of the magnitude of the minimum angle separating the analyzer beam polarization and the sample cell beam polarization. This direction and magnitude information is used in controller 9 to rotate the polarizer in analyzer 5 so as to “null” the component of rotation of the polarization induced by the sample being measured (sample cell 4). That is, motor 8 and controller 9 are in a feedback loop which adjusts the polarizer 5a in analyzer 5 so as to just compensate the polarization introduced by sample cell 4.

In practice, before use, the device of FIG. 1 would be calibrated by determining the null setting necessary when no sample is present. This becomes a zero reference value. Thereafter, any angle adjustment needed to null the system when a sample is present constitutes a measurement of the polarization rotation caused by the sample cell 4.

In its simplest form, Faraday cell 3 would be a transparent rod made of a suitable material which is oriented axially to the direction of the light beam. A coil driven by signal generator 7 is wound helically over the rod. Signal generator 7 would typically provide an oscillating current of sufficient strength to produce the desired effect within the rod. As an example, a faraday cell for use with visible light could be made with a rod made of dense flint glass. The coil wound over the rod would preferably include 1000 to 3000 windings, and signal generator 7 would produce a current in the range of one ampere at a frequency in the range of 10 to 100 Hertz. The resulting rotation of the plane of polarization by the Faraday cell would have an amplitude of a few degrees over the visible wavelengths.

In polarimeters of the type just described, the resolution of angular polarization measurement that can be achieved is typically limited by imperfections in the mechanics of the rotatable analyzer. For example, bearing roughness, backlash, static friction, lubrication issues, as well as the resolution and linearity of available encoders to operate the drive motor limit the practical resolution to the 1 millidegree range.

In an effort to avoid the limitations of mechanically based polarimeters, such as the one illustrated in FIG. 1, the prior art has replaced mechanical components with electronic ones. For example, FIG. 2 is a schematic block diagram of a second type of prior art polarimeter. Many of the components of this second type of polarimeter are identical to those in the first type illustrated in FIG. 1, and these components operate in essentially the same matter. They have therefore been marked with the same reference characters and, for convenience of description, will not be discussed further here.

The essential difference between the polarimeter of FIG. 2 and the first type of polarimeter (FIG. 1) is that the mechanical motor and encoder unit 8 has been replaced with an additional faraday cell 10. Essentially, the rotation caused in FIG. 1 by the mechanical means is replaced with an equivalent electronic means.

By limiting the measurable range of angular polarization introduced by sample cell 4, the art has been able to further simplify the structure of a polarimeter. Specifically, if one is willing to accept measurable polarization which is on the order of the same, or less, of the rotation as produced by Faraday cell 3, a third type of prior art polarimeter becomes possible. This type of polarimeter it is represented by the schematic block diagram of FIG. 3. In this case, the motor 8 of FIG. 1 or the second Faraday cell 10 and amplifier 11 of FIG. 2 may be omitted. The components present in FIG. 3 are identified by reference characters which are present in FIG. 1 or FIG. 2 and operate in the same manner as the corresponding components and those figures represented by the same reference characters.

Fixed analyzer 5 is then set up to extinguish the mean plane of polarization when no sample is present. When a sample is present, Fourier analysis of the intensity variation of light presented to phase sensitive detector 6 determines the sign and magnitude of polarization rotation introduced by the sample to be measured. In particular, if the current in Faraday cell 3 is a pure sinusoid of a given frequency, then the sign and magnitude of the optical polarization rotation introduced in the sample is determined by the Fourier coefficients of the fundamental and harmonic of the given frequency. Unlike the first two systems, this is not a nulling arrangement. The result is determined by analysis of the system operating in an unbalanced or non-nulled state.

One limitation of polarimeters of the first type is the mechanical accuracy of the motor.

Another limitation on the performance of prior art polarimeters of the second and third types is related to stray magnetic fields from the Faraday cell permeating the sample cell area. Such fields may either interact directly with the sample to be measured by inducing additional optical rotation, or residual magnetism and the materials of the sample cell may cause the Faraday cell to exhibit nonlinearity in the relationship between coil current and optical rotation. These fields are difficult to shield, and the size constraints of a benchtop instrument typically do not allow the sample cell to be sufficiently distant, from the Faraday cell. Although mechanical polarimeters also utilize a Faraday cell, they are not affected similarly, because the angular position of the null is not a function of the exact amplitude of the oscillating polarization.

Yet another limitation on the performance of prior art polarimeters of the second and third type is related to stray, or ghosts, reflections from optical surfaces in the path. Such reflections cause a portion of the light to make multiple passes through the Faraday cell. Inasmuch as the direction of rotation in the Faraday cell depends on the direction of the light propagation relative to the magnetic field direction, each pass accumulates additional rotation of the plane of polarization, increasing the amount of rotation induced for a given current. When these reflections are caused by the surfaces of movable elements, such as the windows of removable sample cells or calibration plates, the total induced rotation for a given current becomes unpredictable. If the instrument is designed to operate at a single wavelength, the resultant error can be reduced by using anti-reflection coatings optimized for that wavelength on the critical surfaces. However, modern laboratory instruments operate over multiple wavelengths, and the compromised performance of broadband antireflection coatings is not sufficient to eliminate this source of error.

There is therefore need in the art for a method and apparatus to achieve multiple wavelength polarimetry with high measurement resolution, without suffering errors due to stray magnetic fields or stray reflections or mechanical imperfections associated with moving elements.

### SUMMARY OF THE INVENTION

The present invention relates to polarimeters of the type in which light polarization rotating properties of a sample are measured by interposing the sample in the path of a light beam having base plane polarization in a plane of known orientation; along the beam path, compensating or nulling the rotation introduced by the sample; and determining the optical rotational properties of the sample based on the amount of compensation introduced to the light beam. In accordance with one aspect of the present invention, the light beam is subjected to plural compensations along its path, the compensations being of at least two different types. Preferably, one of the types of compensation is mechanical, introduced through a device in which polarization rotation is adjusted mechanically, and the second type of compensation is provided through a device in which polarization rotation is controlled electrically.

In accordance with another aspect of the invention, a first polarization rotation compensation is performed with the sample in the beam path, the sample is removed, and compensation is restored by performing a second polarization rotation compensation, the second compensation being used to determine the polarization rotation introduced by the sample. Preferably, the first compensation is of a type which will not introduce disturbances in the sample that can interfere with accuracy of rotation compensation, while the second type of compensation is of a type that may introduce such disturbances.

In a preferred embodiment, a Faraday cell in the beam path provides electrically controlled polarization rotation compensation, and a mechanically operated polarizer in the beam path provides mechanically controlled polarization rotation compensation. The mechanical compensation is performed with the sample present and compensation via the Faraday cell is performed after the sample is removed.

### BRIEF DESCRIPTION OF THE DRAWINGS

The foregoing brief description and further objects, features and advantages of the present invention will be understood more completely from the following detailed description of presently preferred, but nonetheless illustrative, embodiments in accordance with the present invention, with reference being had to the accompanying drawings, in which:

FIG. 1 is a schematic block diagram of a first type of prior art polarimeter;

FIG. 2 is a schematic block diagram of a second type of prior art polarimeter;

FIG. 3 is a schematic block diagram of a third type of prior art polarimeter;

FIG. 4 is a schematic block diagram of a polarimeter embodying the present invention; and

FIG. 5 is a flowchart illustrating a preferred process for nulling the polarimeter of FIG. 4.

### DETAILED DESCRIPTION OF THE PREFERRED EMBODIMENTS

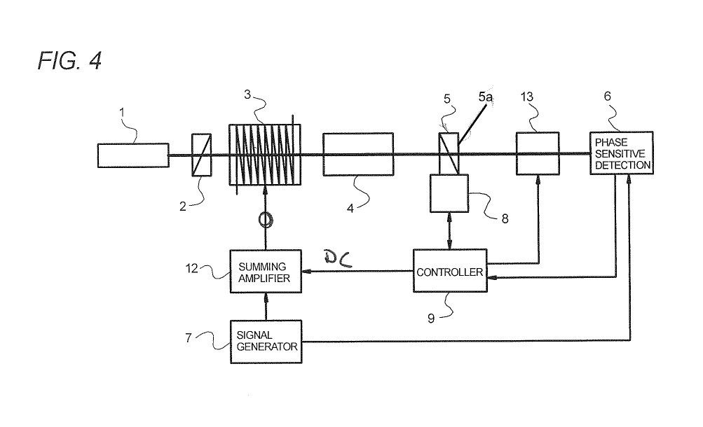

FIG. 4 is a schematic block diagram of a polarimeter embodying the present invention. A broadband light source 1 provides a beam of substantially parallel light which is projected through a fixed polarizer 2, producing a beam with a single plane polarized component at each wavelength. This polarized beam passes through a Faraday cell 3, into and through a sample cell 4, which contains the optically active sample to be measured. The light beam exiting sample cell 4, which has had additional optical rotation induced into it by the sample, then passes into and through an optical analyzer 5, followed by a wavelength selector 13, to arrive at the phase sensitive detector 6.

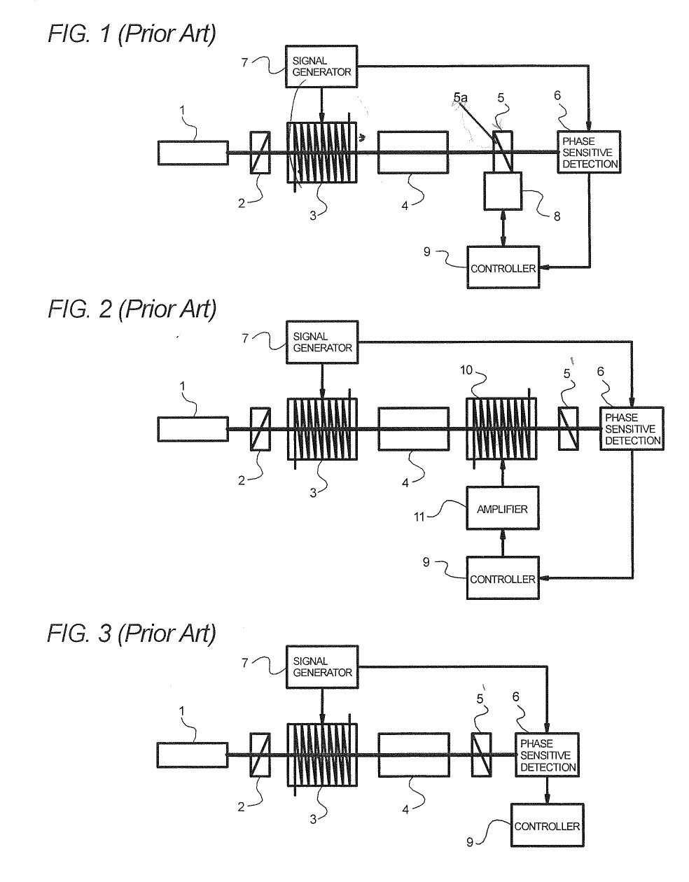

Phase sensitive detector 6 is responsive to the received light beam, to produce a signal, presented to a controller 9, which signal represents the difference in beam polarization direction between light emanating from analyzer 5 and light emanating from sample cell 4. As was the case in FIG. 1, controller 9 controls the motor 8, which rotates the variable polarizer 5a in analyzer 5, to achieve nulling. However, controller 9 also controls wavelength selector 13. Acting through a summing amplifier 12, controller 9 also controls Faraday cell 3. Also provided to summing amplifier 12 is the signal from signal generator 7, which is also provided to phase sensitive detector 6.

In operation, the signal from signal generator 7 effectively passes through summing amplifier 12 to the winding of Faraday cell 3. As was the case in FIG. 1, signal generator 7 produces an oscillating signal, which causes light emanating from the Faraday cell 3 to exhibit a plane of rotation which oscillates about the fixed orientation beam (base plane) orientation produced by polarizer 2. At the same time, a signal from controller 9 is introduced to Faraday cell 3 through summing amplifier 12 and is superimposed over the signal from generator 7. Functionally, the provision of summing amplifier 12 is equivalent to having the Faraday cells 3 and 10 and the amplifier 11, as shown in FIG. 2. In other words, controller 9 provides an additional and independent nulling action through Faraday cell 3, in addition to that provided through analyzer 5.

Wavelength selector 13 is preferably a motorized monochrometer, or filter wheel, provided to isolate the wavelength of interest. Controller 9 acts of wavelength selector 13 to set it to the appropriate wavelength. Certain wavelengths may be totally absorbed by a sample, so it is necessary to use a different wavelength. Also the wavelength may be chosen to maximize the rotation induced by the sample.

As already explained above, the intensity of the beam arriving at the phase sensitive detector 6 is proportional to the cosine squared of the angle between the beam polarization direction of the analyzer 5 and the beam polarization direction of light emanating from sample cell 4. Fourier analysis of the intensity variation with time determines the direction and magnitude of the minimum angle separating sample cell polarization and analyzer polarization directions. This direction and magnitude information is used by controller 9 to rotate polarizer 5a of analyzer 5 or to determine a DC level to be delivered to summing amplifier 12 to null rotation of polarization induced by the sample to be measured. The adjustment required to achieve nulling is indicative of the polarization rotation induced by the sample.

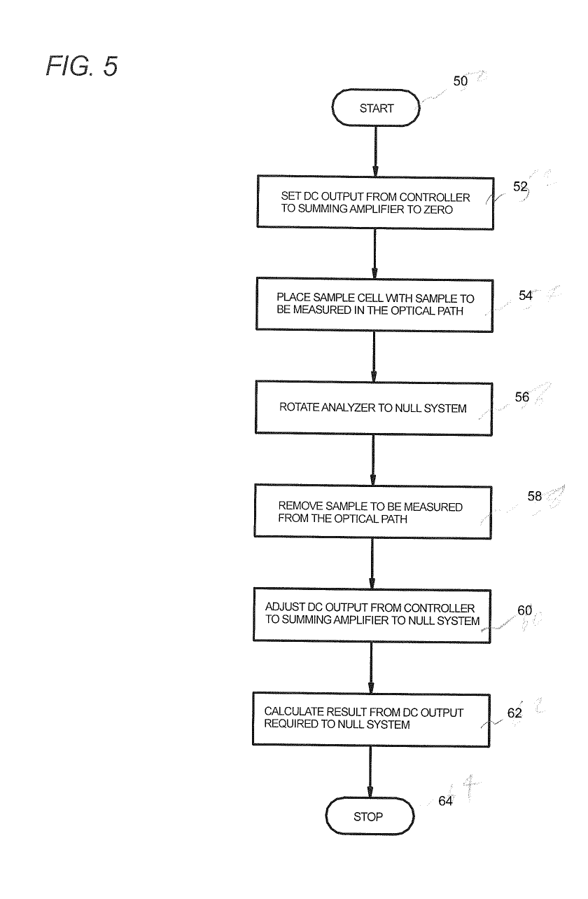

FIG. 5 is a flowchart illustrating a preferred process for nulling the polarimeter of FIG. 4. Processing starts at block 50, and at block 52, the DC output provided from controller 9 to summing amplifier 12 is set to zero when the sample is not present. At block 54 the sample is then introduced in the optical path. At block 56, polarizer 5a of analyzer 5 is then rotated to null the system. This is followed, at block 58, by the removal of the sample from the optical path, and at block 60, by the adjustment of the DC output from controller 9 to summing amplifier 12 to once more null the system. At block 62, the polarization rotation introduced by the sample is determined from the final DC adjustment required to null the system, and the process ends at block 64.

It should be noted that it is only after the sample to be measured is removed from the optical path that the final adjustment is made to the Faraday cell to null the system. This eliminates the three undesirable interactions between the sample and the Faraday cell: additional rotation induced from the sample by stray magnetic fields, disturbance of the Faraday cell residual magnetism of the sample cell materials, and stray or ghost reflections from the optical surfaces of the sample cell.

Although preferred embodiments of the invention have been disclosed for illustrative purposes, those skilled in the will appreciate that many additions, modifications, and substitutions are possible, without departing from the scope and spirit of the invention as defined by the accompanying claims.

1. In a polarimeter a method for compensating rotation introduced by a sample comprising the steps of:
nulling rotation caused by the sample with a first compensation means; and
removing said sample; and
nulling said rotation again with a second compensation means.

2. The method of claim 1 wherein the first and second compensation means are of two different types.

3. The method of claim 2 wherein a first type of polarization rotation compensation is introduced to the light beam mechanically and a second type of compensation is introduced electrically.

4. The method of claim 3 wherein the second type of compensation means effects the optical properties of the sample more than the first compensation means.

5. The method of claim 3 wherein the second type of compensation is introduced through the use of a Faraday cell.

6. The method of claim 3, wherein the first type polarization rotation compensation is performed with the sample in the beam path, the sample is removed, and compensation is restored by performing the second polarization rotation compensation, the second compensation being used to determine the polarization rotation introduced by the sample.

7. The method of claim 6 wherein the first type of compensation is introduced through the use of a mechanically moved device.

8. The method of claim 6 wherein the second type of compensation is introduced through the use of a Faraday cell.

9. In a polarimeter in which light polarization rotating properties of a sample are measured by interposing the sample in the path of a light beam having base plane polarization in a plane of known orientation; along the beam path, compensating the rotation introduced by the sample, and determining the optical rotational properties of the sample based on the amount of polarization rotation compensation introduced to the light beam, a method for compensating rotation introduced by the sample comprising the steps of:
subjecting the beam to a first polarization rotation compensation along its path, performed with the sample in the beam path;
removing the sample from the beam path;
subjecting the beam to a second polarization rotation compensation; and
using the second compensation to determine the polarization rotation introduced by the sample.

10. The method of claim 9 wherein the first and second compensations are of two different types.

11. The method of claim 10 wherein the first type of polarization rotation compensation is introduced to the light beam mechanically and the second type of compensation is introduced electrically.

12. The method of claim 11 wherein the first type of compensation is introduced through the use of a mechanically moved device.

13. The method of claim 11 wherein the second type of compensation is introduced through the use of a Faraday cell.

14. A polarimeter comprising:
a light source providing, along an optical path, a light beam having base polarization in a plane of known orientation;
a sample to be measured disposed along optical path, the sample inducing polarization rotation to the light beam; and
a plurality of polarization rotation compensators along the optical path constructed to compensate polarization rotation introduced by the sample.

15. A polarimeter in accordance with claim 14 wherein said rotation compensators are of at least two different types.

16. A polarimeter in accordance with claim 15 wherein said rotation compensators include a first type which adjusts polarization rotation in response to a physical movement.

17. A polarimeter in accordance with claim 15 wherein said rotation compensators include a second type which adjusts polarization rotation in response to an electrical signal.

18. A polarimeter in accordance with claim 17 wherein said second type of rotation compensator includes a Faraday cell.

19. A polarimeter in accordance with claim 16 further comprising:
means removeably mounting said sample in said optical path; and
a controller which operates a first type of said two types of compensators to compensate polarization rotation when the sample is present and operates a second type of said two types of compensators to compensate polarization rotation when the sample has been removed.

20. A polarimeter in accordance with claim 19 wherein said first type of rotation polarization rotation in response to a physical movement.

21. A polarimeter in accordance with claim 19 wherein said second type rotation compensator adjusts polarization rotation in response to an electrical signal.

22. A polarimeter in accordance with claim 21 wherein said second type of rotation compensator includes a Faraday cell.
